(19) United States
(12) Patent Application Publication
(10) Pub. No.: US 2008/0245832 A1
(43) Pub. Date: Oct. 9, 2008

(54) Fire Extinguisher Carrier

(76) Inventor: Matthew Stephen Willman, West Midlands (GB)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/570,268

(22) PCT Filed: Jun. 9, 2005
(86) PCT No.: PCT/GB05/02277

§ 371 Date: Feb. 19, 2008

(30) Foreign Application Priority Data
Jun. 9, 2004 (GB) 0412886.4
Jul. 2, 2004 (GB) 0414961.3

(51) Int. Cl. A62C 13/78

(52) U.S. Cl. 224/257

(57) ABSTRACT

A fire extinguisher carrier includes upper and lower fixings (46, 47) which are located in use about the body of a fire extinguisher in a spaced apart manner, and are connected by an elongate carry handle (36), whereby the extinguisher can be conveniently carried other than by the usual operating handles (14, 16). An optional shoulder strap (40) is disclosed.

The present invention relates to a fire extinguisher carrier.

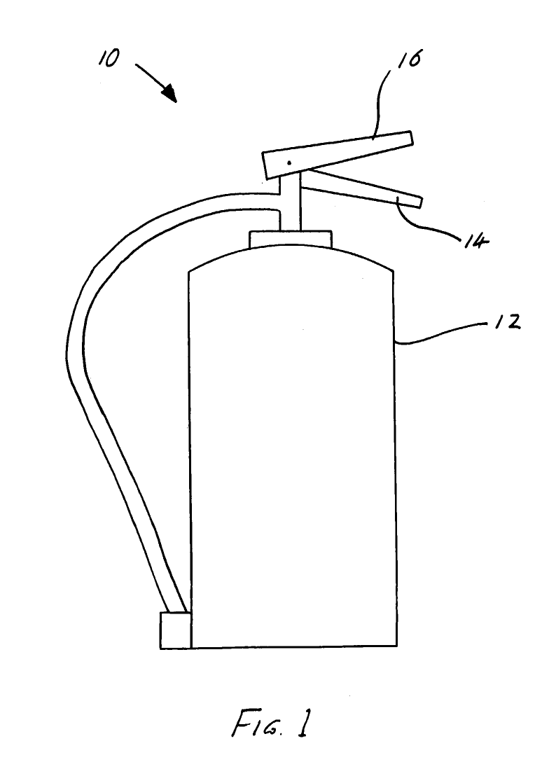

FIG. 1 shows a diagrammatic side view of a typical fire extinguisher, generally designated 10. The fire extinguisher 10 comprises a canister 12 with a support 14 and an operating lever 16. When full the larger fire extinguishers weigh between 12-15 Kg. Fire extinguishers of this kind may be required by law to be located around buildings for use by persons within the building.

Several problems are associated with the existing fire extinguishers. In the event of a fire an untrained person may be required to carry and operate the extinguisher. On approaching a large extinguisher the untrained person may not know whether to carry it by the support or by the operating lever. Furthermore the untrained person may fear activating the fire extinguisher inadvertently and attempt to carry it by grasping the body. This indecision creates confusion and in the event of a fire may waste valuable time before the fire is tackled. Even a trained person may forget the correct way of carrying and use, especially if in a hurry.

A further problem is that the support and the operating lever are not well adapted to carry the weight of the extinguisher; considerable upper body strength is useful, and in any event the conventional support does not make it easy to manoeuvre around and through obstacles. The fire extinguisher tends to act as a pendulum, and can easily collide with the structure of a building or with the user's legs. The support and the operating lever are typically tapered, and of shiny plastics material which is not easy to grip, especially as they are separated, and at a distance unsuitable for small hands. In a panic, where hands may perspire, the grip will in any event be poor. This further wastes time in fighting the fire.

With smaller extinguishers, grasping the body may be possible if the user has large hands, but not if hands are small. What is required is a means of carrying a fire extinguisher, which indicates how and where to grasp the fire extinguisher, which is intuitive, which is unlikely to result in inappropriate action by the user, and which is less likely to result in personal injury.

According to the invention there is provided a fire extinguisher carrier including an upper fixing and a lower fixing, the fixings being located in use about the body of a fire extinguisher in a spaced apart manner and being connected by an elongate member comprising a carry handle, whereby the fire extinguisher can be carried in a non-vertical orientation.

A fire extinguisher carrier so arranged can be retrofitted to a fire extinguisher by demountable fixings so that it is located permanently in position ready for use in the event of a fire. Special adaptation of the fire extinguisher is not required. On approaching the extinguisher the fire fighter is visually drawn to the carry handle which is separate from the support and the operating lever of the extinguisher. Confusion is thus avoided. The carry handle can then be used to transport the fire extinguisher to the scene of a fire more easily than the conventional carrying handle of the fire extinguisher.

The spaced upper and lower fixings support the extinguisher for carrying in a stable and controllable manner. In one embodiment, one of the fixings is adapted for location with respect to the fire extinguisher body, and the other fixing is spaced by a substantially rigid member. The lower fixing may locate under the base, or the upper fixing may locate about the neck so as to bear on the shoulder of the body.

Alternatively both fixings may be adapted for location on the body to prevent movement towards each other, and in this case the carry handle may comprise a flexible member. For example a webbing carrier may locate under the base and about the neck of a fire extinguisher, and the carry handle may also be of webbing. In another example one or both of the fixings may comprise a circumferential clamp ring, such as a worm drive hose clip which may be tightened to the desired degree after fitting over the body of the fire extinguisher. A single such ring may suffice for a lower fixing where the upper fixing locates about the neck of the extinguisher so as to bear on the body thereof.

In another embodiment both fixings comprise clamp rings located about the main cylindrical body of a fire extinguisher and retained in place solely by circumferential clamping forces.

Metal worm drive clamp rings are preferred, but clamp rings of plastic material, for example one-way latching rings, are also possible kinds of upper and/or lower fixings.

The lower fixing may locate on or about the base of the fire extinguisher body.

The carrier may be attached to a fire extinguisher in use, by for example a releasable fastening. Means may be provided to tension the fixings about the body and neck of the fire extinguisher whether or not tension is required to maintain the upper and lower fixings apart. Preferably the carrier is adapted to be a permanent fitting so that once secured to the body of the extinguisher it is an integral part thereof. This ensures that the extinguisher carrier combination is ready for instant use.

In one preferred embodiment the carry handle is substantially rigid. Such a handle may assist in carrying of the extinguisher comfortably, and may include a moulded hand grip.

In another preferred embodiment the carry handle is flexible, for example a webbing strap, and has a substantially rigid, preferably moulded hand grip thereon.

The carry handle may be rubberised. This feature may assist with gripping and carrying of the carrier.

Preferably the carrier or a part thereof is brightly coloured. This may be a particularly advantageous feature to assist greater visibility of the carrier in the dark or in thick smoke. The carrier may also be reflective and/or luminous.

The fixings may for example comprise one or more straps to encircle the body of the fire extinguisher.

In one embodiment the straps are of flexible material, and separated by a plurality of elongate members.

Each strap may be continuous and may be provided with a fastener for adjusting the length and tension of each strap. A strap with free ends having a hook and loop fastener is convenient and easily fitted to a fire extinguisher body.

The carrier may be constructed at least partly of a webbing material.

The carrier may include a tray into which the base of the fire extinguisher is located. Such a tray may supplement or replace a conventional base of a fire extinguisher body. The tray may be semi-rigid, e.g. of plastic, or flexible, e.g. of webbing material. The tray may constitute the lower fixing.

In a preferred embodiment the carrier is fire resistant. The carrier is also preferably substantially fire proof.

The carrier of the invention permits the carrying and operating aspects to be de-coupled, so that the operating lever and support can be optimised for activating the extinguisher.

The carrier is preferably adapted so as to not obscure wording on the fire extinguisher. It may itself carry wording to assist the user, and may be colour coded to suit the extinguisher for which it is intended.

In the most preferred embodiment the carrier comprises rigid bands for encircling the top and base of the container, and a flexible webbing strap connecting the bands and having a moulded plastic handle. The rigid bands may for example comprise adjustable circumferentially extending metal bands of the kind used to secure hoses to pipes. The circumference of such a clip is adjustable, and accordingly it may be tightened to the desired degree. The metal bands may be enclosed within respective flexible sleeves, which may be colour coded.

In carrying an extinguisher both upper and lower fixing will tend towards the middle of the body. The upper fixing at the neck, bears on the shoulder of the body, and thus the very tight fixing of a hose clip may not be necessary.

Similarly, the bottom fixing may locate around the base and thus not require a tight circumferential grip; alternatively a hose clip of the required size can give adequate grip if used about the body in isolation. Preferably the lower fixing is in the vicinity of the bottom diaphragm of the extinguisher, and thus resistant to crushing the extinguisher wall.

In a preferred embodiment the carrier of the invention further comprises a shoulder strap, which is preferably demountable. For example the carrier may incorporate rings adjacent the upper and lower fixings to which the respective ends of a shoulder strap may be attached by swivels and/or snap-on clips. A shoulder pad may be included to spread the load.

This optional feature permits a user to sling an extinguisher over the shoulder, where it may more conveniently be carried to the site of a fire. The shoulder strap is typically of flexible webbing, and the rings may be conventional ‘D’ rings sewn in the webbing of a carrier according to the principle invention.

A particular advantage of the invention is that it does not look out of place, or appear as an accessory. The carrier of the invention complements the extinguisher and provides an immediate and clear visual indication of the intended manner of use.

Other features of the invention will be apparent from the following description of a preferred embodiment shown by way of example only in the accompanying drawings, in which;

FIG. 1 is a diagrammatic side view of a typical fire extinguisher.

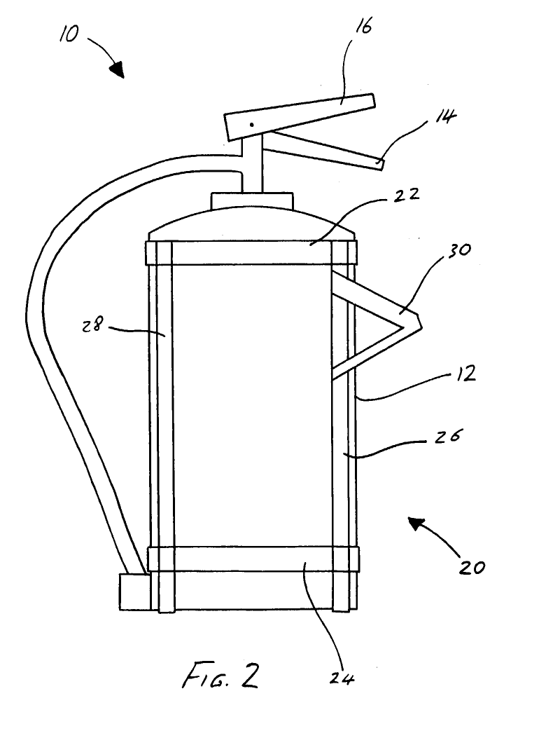

FIG. 2 is a diagrammatic side view of the fire extinguisher of FIG. 1 with a carrier according to the present invention.

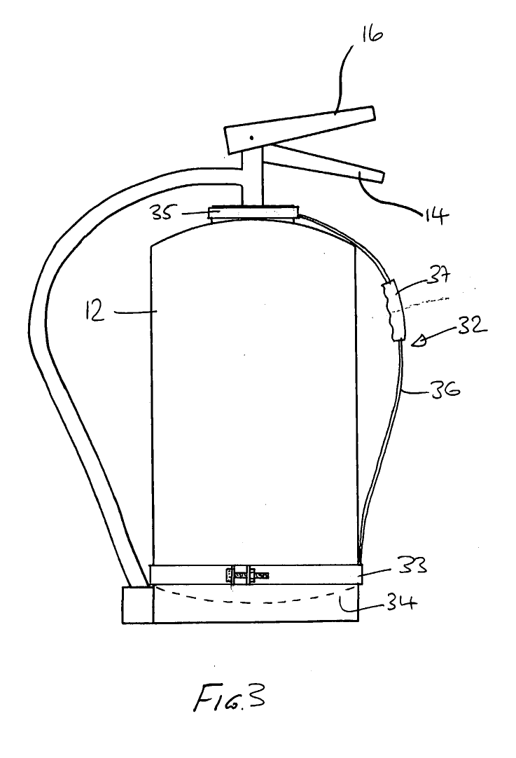

FIG. 3 is a diagrammatic side view of the fire extinguisher of FIG. 1 with an alternative carrier, and

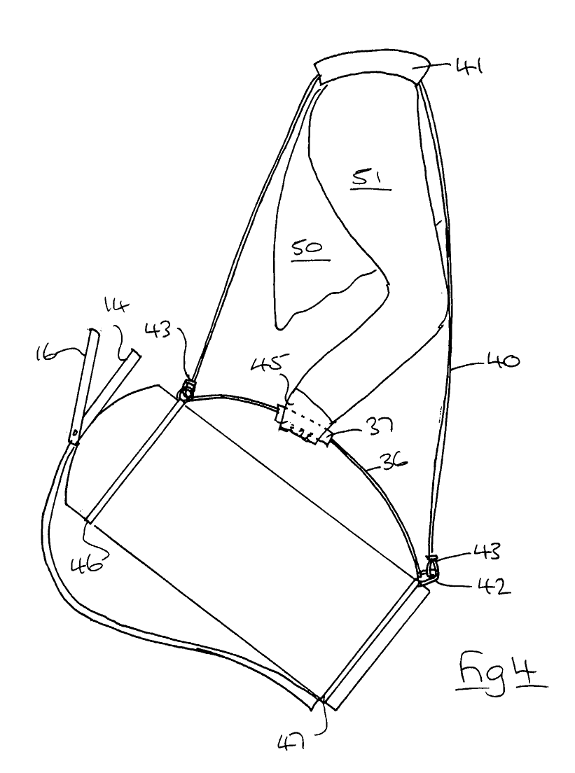

FIG. 4 is a diagrammatic side view of a carrier according to the invention with shoulder strap.

In FIG. 2 there is shown a diagrammatic side view of the fire extinguisher of FIG. 1 with a carrier according to the present invention, generally designated 20. The carrier 20 comprises an upper strap 22 and a lower strap 24 which are adapted for location around the fire extinguisher 10. The upper strap 22 and the lower strap 24 are spaced apart by two elongate semi-rigid members 26, 28. The elongate members 26, 28 pass under the base of the fire extinguisher 10 to hold it within the straps 22, 24. The carrier 20 is further provided with a carry handle 30 which is mounted on one of the elongate members 26. Each of the upper strap 22 and the lower strap 24 are of a webbing material. The elongate members 26,28 are of a webbing material having a stiffener embedded therein (not shown). The carry handle 30 is of substantially rigid material for ease of use, and may be mounted at an angle so that the extinguisher 10 can be carried at a comfortable orientation with a suitable weight distribution. The preferred orientation of the extinguisher whilst being carried can be determined empirically. This embodiment does not rely on tight circumferential fixings of the carrier. A rigid handle is more comfortable in use, and allows the load to be spread, in contrast to a simple strap; suitable finger grip recesses may be easily provided in a moulded handle.

In FIG. 3 there is shown a diagrammatic side view of the fire extinguisher of FIG. 1 with an alternative carrier 32 adapted to permit the extinguisher to be carried with the axis tending towards the horizontal.

The carrier 32 consists of a lower metal clamp band 33 having a screw threaded fastener for tightening thereof. The band is located in the vicinity of the lower diaphragm of the fire extinguisher, indicated by dotted line 34, and preferably overlies it.

The upper fixing also comprises a metal clamp band 35 (clamp screw not shown), but may alternatively be a tight fitting ring adapted to be pressed into place. The strap 36 comprises a flexible webbing material 20-25 mm in width, and a soft plastic handle 37 located thereon at a position selected to give comfortable balance. The handle may for example be selected to give a carrying angle of 30-45° so that the extinguisher can be easily set upright at the place of use.

It will be appreciated that the carrier 20,32 may be constructed of fire resistant or fire proof material. The carrier is preferably brightly coloured and may also be reflective to provide high visibility in the dark or in thick smoke.

In use the carrier can be retrofitted to fire extinguishers 10 so that it is located permanently in position ready for use in the event of a fire. On approaching the extinguisher 10 the fire fighter is drawn to the highly visible carry handle 30,32 which is separate from the support 14 and the operating lever 16 of the extinguisher 10. The carry handle 30,32 can then be used to transport the fire extinguisher to the scene of a fire more easily than the support 14 of the fire extinguisher.

Fire extinguishers come in many sizes. It is envisaged that specification of e.g. neck diameter, body diameter and height will be sufficient for the correct carrier to be specified.

FIG. 4 illustrates the upper torso 50 of a human body and an arm 51. A shoulder strap 40 of flexible webbing and having an optional shoulder pad 41 supports an extinguisher carrier. The ends of the strap 40 are removably attached to ‘D’ rings 42 of the carrier, by swivelling snap clips 43. The ‘D’ rings may be sheathed. The shoulder strap may be adjustable in length using any conventional means and allows an alternative carrying method in which the users hand 45 may also grip the soft handle 37. Although not illustrated in FIG. 4, the swivelling clips are preferably sheathed to avoid snagging whilst permitting angular movement. spaced worm drive metal clamp bands 46,47 constitute the upper and lower fixings of the carrier.

Modification or addition may be made to the invention within the scope of the claims appended hereto.

1-10. (canceled)

11. A fire extinguisher carrier including an upper fixing and a lower fixing, the fixings being located in use about the body of a fire extinguisher in spaced apart manner and being connected by an elongate member comprising a carry handle, whereby the fire extinguisher can be carried in a non-vertical orientation.

12. A carrier according to claim 11 wherein said upper and lower fixings comprise a circumferential clamp ring, adapted to be tightened to the desired degree after fitting over the body of a fire extinguisher.

13. A carrier according to claim 11 wherein the carry handle is flexible, and has a substantially rigid hand grip thereon.

14. A carrier according to claim 12 wherein the carry handle is flexible, and has a substantially rigid hand grip thereon.

15. A carrier according to claim 13 wherein said hand grip is of moulded rubber.

16. A carrier according to claim 14 wherein said hand grip is of moulded rubber.

17. A carrier according to claim 11 and of fire resistant material.

18. A carrier according to claim 11 wherein said upper and lower fixings are enclosed within respective flexible sleeves.

19. A carrier according to claim 11 and further comprising a shoulder strap.

20. A carrier according to claim 19 wherein the shoulder strap is demountable.

21. A carrier according to claim 20 wherein the ends of said shoulder strap is provided with snap fitting connectors.

22. A carrier according to claim 19 wherein said shoulder strap is attached to said carrier via swivels at either end thereof.

23. A carrier according to claim 20 wherein said shoulder strap is attached to said carrier via swivels at either end thereof.

24. A carrier according to claim 21 wherein said shoulder strap is attached to said carrier via swivels at either end thereof.
